(19) United States
(12) Patent Application Publication
(10) Pub. No.: US 2025/0113091 A1
(43) Pub. Date: Apr. 3, 2025

(54) DIGITAL TELESCOPE COMBINED WITH MOBILE APPLICATION

(71) Applicant: Beaver Technology (Shenzhen) Co., Ltd., Shenzhen (CN)

(72) Inventors: Hongfei FANG, Shenzhen (CN); Wei WANG, Shenzhen (CN); Han CHEN, Shenzhen (CN); Qi'en WU, Shenzhen (CN); Zeshuo TIAN, Shenzhen (CN); Chenxi ZENG, Shenzhen (CN); Shengge YOU, Shenzhen (CN); Huanzheng ZHENG, Shenzhen (CN)

(73) Assignee: Beaver Technology (Shenzhen) Co., Ltd., Shenzhen (CN)

(21) Appl. No.: 18/532,361

(22) Filed: Dec. 7, 2023

(30) Foreign Application Priority Data
Sep. 28, 2023 (CN) 202311284955X

(51) Int. Cl. H04N 23/53; G02B 23/12; H04M 1/02; H04N 23/66; H04N 23/667

(52) U.S. Cl. CPC H04N 23/531; G02B 23/12; H04M 1/0264; H04N 23/66; H04N 23/667

(57) ABSTRACT

Disclosed herein is a digital telescope combined with a mobile application, including a lens barrel structure, a night-vision optical structure and a mobile phone fixing device, where an optical module and a CMOS digital circuit module are mounted in the lens barrel structure, the night-vision optical structure is assembled below the lens barrel structure, and the mobile phone fixing device is mounted on one side of the lens barrel structure. With regard to the digital telescope, watching by means of the telescope is more comfortable and easier, data storage is facilitated, a night-vision observation screen has a better picture quality effect, and comfortable observation is achieved; meanwhile, data transmission is facilitated by a digital camera, and a window for the observation screen is larger; in addition, a circuit device and a process device of the telescope are made of common materials, are low in cost and are easy to supply.

### CROSS-REFERENCE TO RELATED APPLICATIONS

The application claims priority to Chinese patent application No. 202311284955X, filed on Sep. 28, 2023, the entire contents of which are incorporated herein by reference.

### TECHNICAL FIELD

The present disclosure relates to the field of digital equipment, in particular to a digital telescope combined with a mobile application.

### BACKGROUND

A telescope is an optical instrument for observing a distant object by means of a lens or a reflector and other optical devices, light passing the lens is refracted or light is reflected by a concave mirror to enter a small hole to be converged into an image, and then the image can be seen by means of a magnification eyepiece. At present, most telescopes on the market are based on optical eyepieces to achieve observation of scenery by naked eyes. However, the telescopes cannot photograph or record the observed scenery, and mobile phone cameras need to be used at the optical eyepieces for photographing and recording when photographing is needed.

A night-vision instrument is a night infrared sight taking an image intensifier as a core device, during operation, an infrared searchlight is not used to illuminate a target, but light reflected by the target under weak light is enhanced on a fluorescent screen by the image intensifier into a visible image, which is perceptible to human eyes, to observe and aim the target. Besides, with regard to most night-vision instruments on the market, display is achieved on integrated screens by means of optical projections to complementary metal-oxide semiconductor (CMOS) modules (cameras), resulting in excessively high costs and small observation windows, and meanwhile, there is a problem of non-ideal display effect of the screens.

In addition, at present, smart cameras on the market are in the form of integrating screens, optical systems and CMOS camera sensors, it is inconvenient to import picture data into mobile phones, and it is inconvenient to observe due to the small screens. Therefore, a digital telescope combined with a mobile application is provided.

### SUMMARY

The present disclosure mainly aims to provide a digital telescope combined with a mobile application, so as to solve the problems that existing telescopes, night-vision instruments and cameras are inconvenient to turn during use, are inconvenient in object recording and observation and are uncomfortable to observe due to small screens.

In order to achieve the above purpose, the following technical solution is adopted for the present disclosure: the digital telescope combined with a mobile application comprises a lens barrel structure, a night-vision optical structure and a mobile phone fixing device, where an optical module and a CMOS digital circuit module are mounted in the lens barrel structure, the night-vision optical structure is assembled below the lens barrel structure, and the mobile phone fixing device is mounted on one side of the lens barrel structure. Specifically, a hardware portion comprises a lens barrel optical system structure, a CMOS digital photographing module structure, an optical system module and a mobile phone adapter structure, where the CMOS digital circuit module is composed of a main control circuit module, a camera circuit module, a battery module and an embeddable and superposable night-vision circuit module, and the lens barrel optical system structure is composed of an optical objective system and a replaceable and superposable night-vision optical system.

Preferably, the optical module comprises the optical objective system and the replaceable and superposable night-vision optical system, the optical objective system is adapted to the night-vision optical system in position, and the digital circuit module comprises the main control circuit module, the camera circuit module, the battery module and the embeddable and superposable night-vision circuit module.

The mobile phone fixing device comprises clamping plates and a connecting column, the clamping plates are movably connected to the mobile phone fixing device, the connecting column is connected to one side of the mobile phone fixing device, and one end of the connecting column is connected to the lens barrel structure.

Preferably, the mobile phone fixing device is configured to fix mobile phone equipment, the mobile phone equipment is assembled on the mobile phone fixing device, the mobile phone equipment is connected by means of a data cable so as to achieve wired connection, and wireless connection of the mobile phone equipment is achieved by means of WIFI.

The optical module and the CMOS digital circuit module are in buckle connection in the lens barrel structure, and the optical module is electrically connected to the CMOS digital circuit module.

Preferably, the battery module is respectively electrically connected to the main control circuit module, the camera circuit module and the night-vision circuit module, and the main control circuit module is respectively electrically connected to the camera circuit module and the night-vision circuit module.

There are two clamping plates, and the two clamping plates form a mobile phone clamping region on a surface of the mobile phone fixing device.

The telescope in the present disclosure matches corresponding mobile terminal control APP software, during use, the mobile software is connected to the telescope by means of the data cable, a distant or night target object can be observed by means of the APP software, and real-time recording and photographing functions are supported by the APP software.

The present disclosure has the following beneficial effects:

with regard to the digital telescope combined with the mobile application in the present disclosure, watching by means of the telescope is more comfortable and easier, data storage is facilitated, a night-vision observation screen has a better picture quality effect, and comfortable observation is achieved; meanwhile, it is more convenient for data transmission by using a digital camera, and a window for the observation screen is larger; in addition, a circuit device and a process device that are used in the telescope are made of common materials, are low in cost and are easy to supply.

### BRIEF DESCRIPTION OF DRAWINGS

FIG. 1 is a schematic diagram of an overall structure of a digital telescope combined with a mobile application in the present disclosure; and

FIG. 2 is an explanatory diagram of an operation circuit of the digital telescope combined with a mobile application in the present disclosure.

In the drawings: 1. lens barrel structure; 2. night-vision optical structure; 3. mobile phone fixing device; 4. clamping plate; and 5. connecting column.

### DETAILED DESCRIPTION OF THE EMBODIMENTS

In order to make the above purpose, features and advantages of the present disclosure more obvious and understandable, specific embodiments of the present disclosure are described in detail in conjunction with the accompanying drawings below. Many details are elaborated in the following description to facilitate a full understanding of the present disclosure. However, the present disclosure can be implemented in many other manners different from the manner described here, those skilled in the art can make similar improvements without departing from the connotations of the present disclosure, and thus the present disclosure is not limited by the specific embodiments disclosed below. In the description of the present disclosure, it should be understood that orientation or position relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like are orientation or position relationships based on the accompanying drawings, are only for the purposes of facilitating the description of the present disclosure and simplifying the description, and do not indicate or imply that a device or an element referred to must have the specific orientation or be constructed and operated in the specific orientation. Therefore, they cannot be understood as limitations on the present disclosure.

In the present disclosure, unless otherwise explicitly specified and limited, the terms “mounting”, “connecting”, “connection”, “fixing” and the like should be understood in a broad sense, for example, they may be fixed connection, and may also be detachable connection or integrated connection; they may be mechanical connection, and may also be electrical connection; and they may be direct connection, may also be indirect connection by means of intermediate media, and may also be communication of the interiors of two elements or the interactive relationship of two elements. For those of ordinary skill in the art, specific meanings of the above terms in the present disclosure can be understood according to specific circumstances.

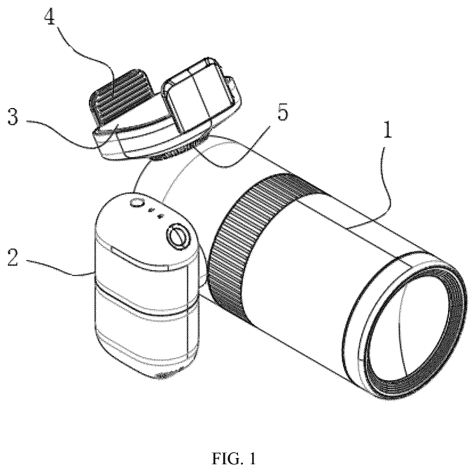

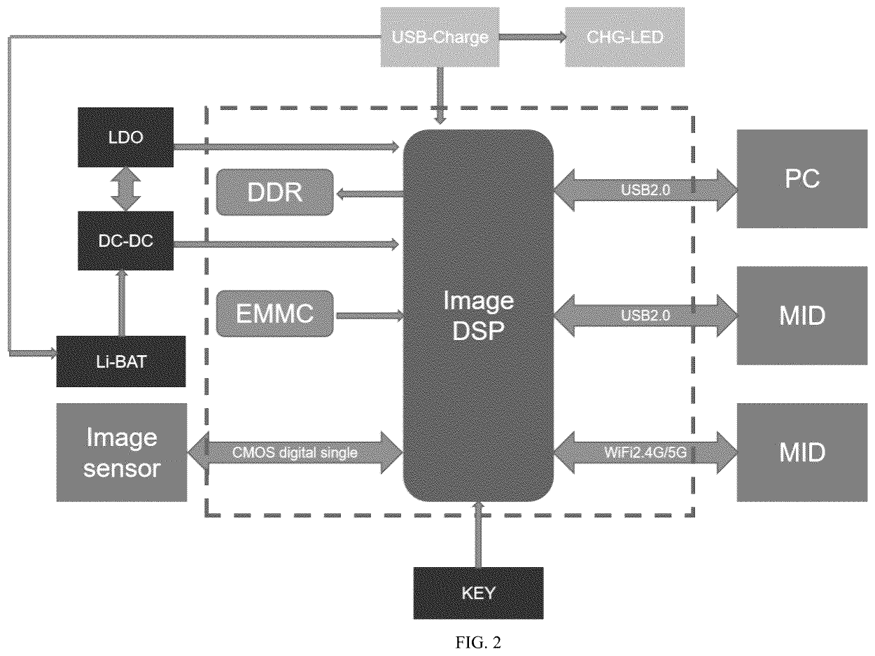

Reference is made to FIGS. 1-2. The present disclosure provides a digital telescope combined with a mobile application, including a lens barrel structure 1, a night-vision optical structure 2 and a mobile phone fixing device 3, where an optical module and a CMOS digital circuit module are mounted in the lens barrel structure 1, the night-vision optical structure 2 is assembled below the lens barrel structure 1, and the mobile phone fixing device 3 is mounted on one side of the lens barrel structure 1.

The optical module includes an optical objective system and a replaceable and superposable night-vision optical system, the optical objective system is adapted to the night-vision optical system in position, and the digital circuit module includes a main control circuit module, a camera circuit module, a battery module and an embeddable and superposable night-vision circuit module. The mobile phone fixing device 3 includes clamping plates 4 and a connecting column 5, the clamping plates 4 are movably connected to the mobile phone fixing device 3, the connecting column 5 is connected to one side of the mobile phone fixing device 3, and one end of the connecting column 5 is connected to the lens barrel structure 1 so as to mount and fix a mobile phone. The mobile phone fixing device 3 is configured to fix mobile phone equipment, the mobile phone equipment is assembled on the mobile phone fixing device 3, the mobile phone equipment is connected by means of a data cable so as to achieve wired connection, and wireless connection of the mobile phone equipment is achieved by means of WIFI.

The optical module and the CMOS digital circuit module are in buckle connection in the lens barrel structure 1, so that assembly, disassembly and maintenance of various modules are facilitated, and the operation is convenient. The optical module is electrically connected to the CMOS digital circuit module, so that data transmission is facilitated. The battery module is respectively electrically connected to the main control circuit module, the camera circuit module and the night-vision circuit module, and the battery module is configured to provide electric energy for various control modules and operation modules. The main control circuit module is respectively electrically connected to the camera circuit module and the night-vision circuit module, and the control controllability of the operation modules is enhanced. There are two clamping plates 4, and the two clamping plates 4 form a mobile phone clamping region on a surface of the mobile phone fixing device 3, so that the clamping stability for the mobile phone equipment is enhanced.

In the present disclosure, an image processor of the digital telescope adopts Novatek-NT96580-10Mp30-H264/H265 video coding; the operating main frequency is Dual-core-1 GHz; a RAM is 4 GB-DDR3; a ROM is a built-in EMMC, including 16G/32G/64G/128G; a main camera image sensor is IMX678/SC850SL-800 million; APP backend application is supported; wireless connection includes built-in 5.8 GHz-WIFI, supports 802.11a/b/g/n, and has a built-in antenna; image tracking is image calibration tracking; anti-shake processing includes gyroscope and algorithm anti-shake processing; image processing includes (HRD, long exposure, white balance, saturation processing)—hardware, (sharpening, stacking processing)—mobile client; and manual focusing is adopted during focusing.

With regard to the digital telescope combined with the mobile application in the present disclosure, a hardware portion includes a lens barrel optical system structure, a CMOS digital photographing module structure, an optical system module and a mobile phone adapter structure, where the CMOS digital circuit module is composed of the main control circuit module, the camera circuit module, the battery module and the embeddable and superposable night-vision circuit module, and the lens barrel optical system structure is composed of the optical objective system and the replaceable and superposable night-vision optical system. The digital telescope matches corresponding mobile terminal control APP software, during use, the mobile software is connected to the telescope by means of the data cable, a distant or night target object can be observed by means of the APP software, and real-time recording and photographing functions are supported by the APP software.

With regard to the digital telescope combined with the mobile application in the present disclosure, during use, the digital telescope is turned on by means of an ON/OFF key on the mobile phone fixing device 3, and meanwhile, the telescope can be used for observation by opening the mobile APP software. The camera circuit module in a digital eyepiece circuit device (optical module) transmits the observed image to the APP software by means of the data cable in real time, meanwhile, the clear image can be seen by focusing by means of a focusing structure on the lens barrel structure 1, the night vision and the normal observation can be switched by means of software operation of the APP software, and at the same time, real-time recording and photographing can be performed.

The basic principles, main features, and advantages of the present disclosure are shown and described above. A person skilled in the art should understand that the present disclosure is not limited by the above embodiments, the descriptions in the above embodiments and specification are only for illustrating the principles of the present disclosure, the present disclosure may be subjected to various changes and improvements without departing from the spirit and scope of the present disclosure, and these changes and improvements should fall within the scope of protection of the present disclosure. The scope of protection of the present disclosure should be subject to the claims and equivalents thereof.

What is claimed is:

1. A digital telescope combined with a mobile application, comprising a lens barrel structure, a night-vision optical structure and a mobile phone fixing device, wherein an optical module and a complementary metal-oxide semiconductor (CMOS) digital circuit module are mounted in the lens barrel structure, the night-vision optical structure is assembled below the lens barrel structure, and the mobile phone fixing device is mounted on one side of the lens barrel structure.

2. The digital telescope combined with a mobile application according to claim 1, wherein the optical module comprises an optical objective system and a replaceable and superposable night-vision optical system, the optical objective system is adapted to the night-vision optical system in position, and the digital circuit module comprises a main control circuit module, a camera circuit module, a battery module and an embeddable and superposable night-vision circuit module.

3. The digital telescope combined with a mobile application according to claim 1, wherein the mobile phone fixing device comprises clamping plates and a connecting column, the clamping plates are movably connected to the mobile phone fixing device, the connecting column is connected to one side of the mobile phone fixing device, and one end of the connecting column is connected to the lens barrel structure.

4. The digital telescope combined with a mobile application according to claim 1, wherein the mobile phone fixing device is configured to fix mobile phone equipment, the mobile phone equipment is assembled on the mobile phone fixing device, the mobile phone equipment is connected by means of a data cable so as to achieve wired connection, and wireless connection of the mobile phone equipment is achieved by means of WIFI.

5. The digital telescope combined with a mobile application according to claim 1, wherein the optical module and the CMOS digital circuit module are in buckle connection in the lens barrel structure, and the optical module is electrically connected to the CMOS digital circuit module.

6. The digital telescope combined with a mobile application according to claim 2, wherein the battery module is respectively electrically connected to the main control circuit module, the camera circuit module and the night-vision circuit module, and the main control circuit module is respectively electrically connected to the camera circuit module and the night-vision circuit module.

7. The digital telescope combined with a mobile application according to claim 3, wherein there are two clamping plates, and the two clamping plates form a mobile phone clamping region on a surface of the mobile phone fixing device.
